(19) United States
(12) Patent Application Publication
(10) Pub. No.: US 2010/0266838 A1
(43) Pub. Date: Oct. 21, 2010

(54) METHOD FOR FABRICATION OF CONDUCTIVE FILM USING METAL WIRE AND CONDUCTIVE FILM

(76) Inventors: Hyun-Jung LEE, Seoul (KR); Hee-Suk KIM, Seoul (KR); Jun-Kyung KIM, Seoul (KR); Kyoung-Ah OH, Seoul (KR); Seung-Woong NAM, Seoul (KR); Soon-Ho LIM, Seoul (KR)

Correspondence Address: OSTROLENK FABER GERB & SOFFEN, 1180 AVENUE OF THE AMERICAS, NEW YORK, NY, 100368403, US

(21) Appl. No.: 12/575,685

(22) Filed: Oct. 8, 2009

(30) Foreign Application Priority Data
Apr. 15, 2009 (KR) 10-2009-0032912

(51) Int. Cl. B32B 5/16; B05D 3/06; B05D 5/12

(52) U.S. Cl. 428/323; 427/565; 427/108; 977/742; 977/750; 977/752; 977/762

(57) ABSTRACT

A method for fabricating a conductive film, and a conductive film fabricated by the same. The method comprises: preprocessing carbon nanotubes by at least one of a cutting step using ultrasonic wave, and a chemical reaction step with acid; dispersing the carbon nanotubes in a solvent; mixing metal wires with the carbon nanotubes dispersion solution; and forming an electrode layer by coating the mixed resultant on a substrate. Accordingly, can be easily fabricated the conductive film having high transmittance and high electric conductivity.

### CROSS-REFERENCE TO RELATED APPLICATIONS

This application claims priority to Korean Application No. 10-2009-0032912, filed on Apr. 15, 2009, which is herein incorporated by reference in its entirety.

### BACKGROUND OF THE INVENTION

1. Field of the Invention

The present invention relates to a method for fabrication of a conductive film having conductivity and light transmittance, and a conductive film fabricated by the same.

2. Background of the Invention

A conductive film is a kind of functional optical film, and is being widely applied to home devices, industrial devices, office devices, etc.

Nowadays, a transparent conductive film having a light transmission characteristic is being widely applied to devices implementing low transparency and low resistance, such as solar cells and each kind of displays (PDP, LCD and OLED). As the transparent conductive film, indium tin oxide (ITO) has been generally used.

However, the ITO has the following disadvantages.

Firstly, the ITO is expensive, and has a low endurance against even a small external impact or stress.

Secondly, the ITO has a weak mechanical stability when being bent or folded.

Thirdly, an electric characteristic of the ITO is varied by thermal deformation due to a difference between a coefficient of thermal expansion of the ITO and that of a substrate.

In order to solve these problems, has been proposed a simple method for fabricating a conductive film.

### SUMMARY OF THE INVENTION

Therefore, an object of the present invention is to provide a method for fabricating a conductive film capable of fabricating a conductive film in a different manner from the conventional art, and a conductive film fabricated by the same.

Another object of the present invention is to provide a conductive film having an enhanced endurance.

To achieve these and other advantages and in accordance with the purpose of the present invention, as embodied and broadly described herein, there is provided a method for fabricating a conductive film, comprising: preprocessing carbon nanotubes by at least one of a cutting step using ultrasonic wave, and a chemical reaction step with acid; dispersing the carbon nanotubes in a solvent; mixing metal wires with the carbon nanotubes dispersion solution; and forming an electrode layer by coating the mixed resultant on a substrate.

According to another aspect of the present invention, the solvent may include at least one of dimethylformamide (DMF), N-methyl-2-pyrrolidone (NMP), ethyl alcohol, water and chlorobenzene. The metal wires may include at least one of gold, silver, copper, and platinum.

According to another aspect of the present invention, the method for fabricating a conductive film may further comprise synthesizing the metal wires by reacting a plurality of materials with one another. The metal wires may have a diameter of 1˜2000 nanometers. The metal wires may have a length of 1˜100 μm. The synthesizing step may include a heating step for heating an ethylene glycol solution, an adding step for adding reactants to the solution for a chemical reaction, and a generating step for generating metal wires by centrifugally separating the solution.

According to another aspect of the present invention, the method for fabricating a conductive film may further comprise adding a conductive polymer to the solvent. The conductive polymer may include at least one of poly 3,4-ethylenedioxythiophene (PEDOT), polypyrrole, and polyaniline.

According to another aspect of the present invention, the method for fabricating a conductive film may further comprise adding an ionic liquid material to the solvent. The ionic liquid material may include at least one of 1-butyl-3-methyl imidazolium, 1-hexyl-3-methyl imidazolium and 1-methyl-3-methyl imidazolium.

According to another aspect of the present invention, the method for fabricating a conductive film may further comprise surface-processing for chemically processing a surface of the substrate so as to implement hydrophilicity or hydrophobicity.

According to another embodiment of the present invention, the method for fabricating a conductive film may comprise synthesizing metal wires through a chemical reaction among a plurality of compounds; dispersing the metal wires and carbon nanotubes in a solvent; and forming an electrode layer on a surface of a transparent substrate by coating the dispersion solution onto the transparent substrate.

To achieve these and other advantages and in accordance with the purpose of the present invention, as embodied and broadly described herein, there is also provided a conductive film, comprising: a transparent substrate; an electrode layer; and metal wires, wherein the electrode layer is formed by coating carbon nanotubes on one surface of the substrate, the metal wires are arranged on the electrode layer so as to be mixed with the carbon nanotubes, and the carbon nanotubes are formed of at least one of single-walled carbon nanotubes, double-walled carbon nanotubes, and multi-walled carbon nanotubes.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a conceptual view of a conductive film according to a first embodiment of the present invention;

FIG. 2 is a flowchart showing a method for fabricating a conductive film according to a first embodiment of the present invention;

FIG. 3 is a flowchart showing a method for synthesizing metal wires to be mixed with the conductive film;

FIG. 4 is a sectional view taken along line ‘IV-IV’ in FIG. 1;

FIGS. 5A and 5B are enlarged views of the conductive film of FIG. 1, which show the conductive film photographed by a scanning electron microscope (SEM); and

FIGS. 6A and 6B are graphs respectively showing surface resistance and transmittance of the conductive film fabricated by the method of FIG. 2.

### DETAILED DESCRIPTION OF THE INVENTION

Description will now be given in detail of the present invention, with reference to the accompanying drawings.

Hereinafter, a method for fabricating a conductive film, and a conductive film fabricated by the same according to the present invention will be explained in more detail with reference to the attached drawings.

The same or similar reference numerals will be given to the same or similar parts in different embodiments, and their detailed explanation will be omitted. The singular expression used in the specification of the present invention may include the meaning of plurality unless otherwise defined.

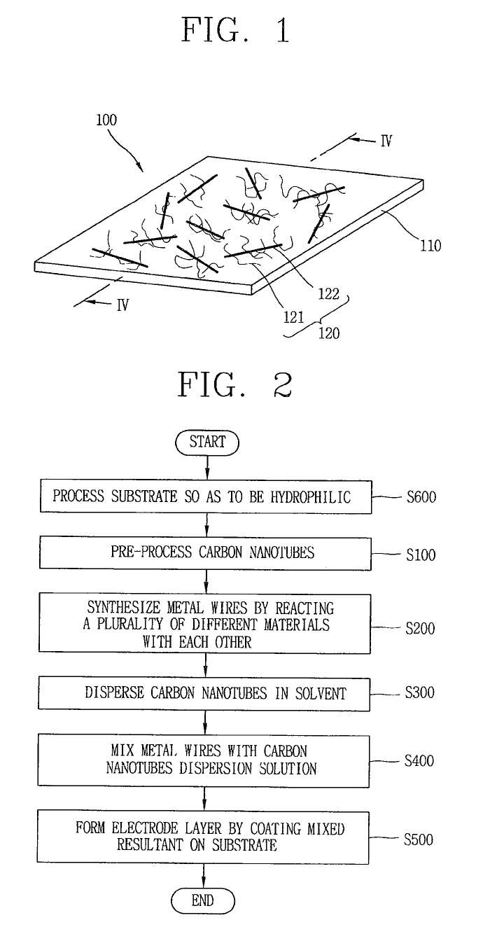

FIG. 1 is a conceptual view of a conductive film according to a first embodiment of the present invention.

Referring to FIG. 1, the conductive film 100 comprises a substrate 110, carbon nanotubes 121, and metal wires 122.

The substrate 110 is formed of a transmissive material, and an electrode layer 120 is formed on one surface of the substrate 110 as carbon nanotubes 121 and metal wires 122 are mixed to each other.

The metal wires 122 are implemented in the form of wire, and serves to maintain a light transmissive degree (hereinafter, will be referred to as ‘transmittance’) of the conductive film 100. Also, the metal wires 122 serve to enhance conductivity of the electrode layer 120.

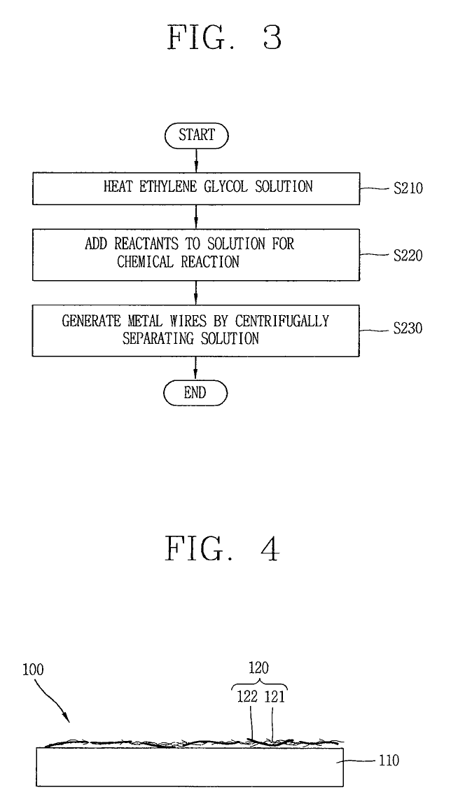

FIG. 2 is a flowchart showing a method for fabricating a conductive film according to a first embodiment of the present invention, and FIG. 3 is a flowchart showing a method for synthesizing metal wires to be mixed with the conductive film.

Firstly, the carbon nanotubes 121 of the conductive film 100 are is preprocessed so as to have an enhanced affinity with a solvent (S100). The preprocessing (S100) is performed by at least one of a cutting step using ultrasonic wave (S110), and a chemical reaction step with acid (S120).

The carbon nanotubes may include at least one of a first group processed by the cutting step using ultrasonic wave (S110), and a second group processed to have hydrophilicity through the chemical reaction step with acid (S120). The first and second groups may be different from each other. However, the present invention is not limited to this. The first group may be processed to have hydrophilicity through a chemical reaction, and the second group may be cut by using ultrasonic wave.

A process for applying ultrasonic wave to the carbon nanotubes will be explained.

Firstly, about 400 mg of carbon nanotubes having a volume ratio of 1 mg/1 ml is dispersed in about 400 ml of a dimethylformamide (DMF) solution. Then, ultrasonic wave is applied to the dispersion solution by using an ultrasonic wave device. The ultrasonic wave device is implemented as a corn-shaped one, and has an output of about 330 W. The cut carbon nanotubes undergo a centrifugal separation process for about 20 minutes with a speed of about 8000 rpm. Finally, the dispersion solution is dried by a dryer. More concretely, the dimethylformamide (DMF) is evaporated by a freeze dryer for an organic solvent, thereby collecting the carbon nanotubes.

The carbon nanotubes having undergone the cutting step (S110) to have short lengths show enhanced dispersability.

In the chemical reaction step with acid (S120), the carbon nanotubes are chemically reacted with acid so as to have hydrophilicity.

The chemical reaction step with acid (S120) may be a step for preparing carbon nanotubes having undergone an acid-treatment so as to have a hydrophilic surface.

The chemical reaction step with acid (S120) will be explained. About 400 mg of carbon nanotubes are immersed in a mixed solution of H₂SO₄ and HNO₃ with a ratio of 3:1. Then, the carbon nanotubes having undergone an acid-treatment for about one hour are neutralized by using water.

Then, the neutralized solution is filtered by a polytetrafluoroethylene (PTFE) membrane, and then is re-neutralized until its PH becomes 7. Then, the carbon nanotubes remaining on membrane filter paper are collected to be dried by a freeze dryer.

At least end portions or side surfaces of the carbon nanotubes having undergone an acid-treatment are provided with a chemical reaction group of ‘—COOH’. Owing to the chemical reaction group, the carbon nanotubes can have enhanced dispersability in a solvent.

The method for fabricating a conductive film may comprise a step of synthesizing metal wires (S200). In the synthesizing step (S200), metal wires are synthesized by reacting a plurality of different materials with each other.

Hereinafter, the synthesizing step (S200) will be explained with reference to FIG. 3.

The metal wires may include at least one of gold, silver, copper, and platinum. The metal wires may be synthesized so as to have a diameter of 1˜2000 nanometers. And, the metal wires may be synthesized so as to have a length of 1˜100 μm.

In the synthesizing step (S200), metal wires are synthesized by chemically reacting a plurality of compounds with each other. In order to synthesize metal wires, an ethylene glycol (EG) solution is heated (S210). For instance, about 5 ml of an EG solution is filled in a flask, and then is thermally processed at a temperature of about 180° for about 30 minutes.

Next, reactants are added to the solution so as to implement a chemical reaction (S220). For instance, ethylene glycol including 1M of AgNO₃ is quickly put into the solution within about 10 seconds. Then, ethylene glycol including polyvinyl pyrrolidone and Na₂S is put into the solution for about 5 minutes. The solution mixed with the reactants is disposed under an argon (Ar) atmosphere for about 20 minutes, thereby maintaining the chemical reaction. Then, the solution is centrifugally separated, thereby generating metal wires (S230). For instance, the solution is washed by using acetone, and is made to undergo a centrifugal separation process using a centrifugal separator with a speed of about 4000 rpm for about 30 minutes. Then, an upper layer liquid including the ethylene glycol is removed, and powder of the metal wires is collected.

Again referring to FIG. 2, the method for fabricating a conductive film comprises a dispersing step (S300) for dispersing carbon nanotubes in a solvent, and a mixing step (S400) for mixing metal wires with the carbon nanotubes dispersion solution.

The solvent may include at least one of dimethylformamide (DMF), N-methyl-2-pyrrolidone (NMP), ethyl alcohol, water and chlorobenzene.

For instance, 3 mg of preprocessed carbon nanotubes of a first group or a second group is put into a dimethylformamide (DMF) solvent, and then is dispersed in a water tank type of ultrasonic wave device for at least three hours. Then, the synthesized metal wires are dispersed in the solvent in a mixed state with the carbon nanotubes. The metal wires may be mixed with the carbon nanotubes with an amount of 1˜200%. Then, ultrasonic wave is applied to the solvent by using the water tank type of ultrasonic wave device for about one hour, thereby fabricating a dispersion solution that the metal wires and the carbon nanotubes are mixed to each other.

The dispersing step (S300) and the mixing step (S400) may be executed without a time order. For instance, the carbon nanotubes and the metal wires may be firstly mixed to each other, and then the mixture may be dispersed in a solvent.

Finally, the dispersion solution that the metal wires and the carbon nanotubes are mixed to each other is coated on the substrate, thereby forming an electrode layer (S500). The electrode layer may be formed on a surface of the substrate, and has electric conductivity as the carbon nanotubes and the metal wires are mixed to each other.

The substrate is formed of a transmissive material. More concretely, the substrate may be formed of at least one of glass, quartz, and synthetic resin.

As the coating method, may be used one of spin coating, chemical vapor deposition (CVD), electrochemical deposition, electrophoretic deposition, sputtering, spray coating, dip-coating, vacuum filtration, airbrushing, and doctor blade.

For instance, the electrode layer may be formed by dropping the quantitative dispersion solution that the carbon nanotubes are mixed with the metal wires, onto a glass substrate, and then by spin-coating the dispersion solution with a speed of about 1500 rpm for about 40 seconds.

The method for fabricating a conductive film may comprise chemically processing a surface of the substrate so as to implement hydrophilicity or hydrophobicity (S600). For instance, the substrate is washed by using piranha solution so as to have hydrophilicity.

Hereinafter, the chemical processing step (S600) will be explained. Firstly, a glass substrate cut into a size of about 1.5×1.5 cm₂ is immersed in a solution that H₂SO₄ and H₂O₂ are mixed to each other with a ratio of 7:3, and is washed for about 30 minutes. Then, the glass substrate is re-washed by using water. Finally, the glass substrate is dried in an oven at a temperature of about 70°. Through these processes, the glass substrate may be made to have hydrophilicity.

The method for fabricating a conductive film may comprise at least one of adding a conductive polymer to a solvent, and adding an ionic liquid material to a solvent. The conductive polymer may include at least one of poly 3,4-ethylenedioxythiophene (PEDOT), polypyrrole and polyaniline. The conductive polymer may serve as a binder when dispersing the carbon nanotubes. The ionic liquid material may include at least one of 1-butyl-3-methyl imidazolium, 1-hexyl-3-methyl imidazolium, and 1-methyl-3-methyl imidazolium. As a result, the carbon nanotubes and the metal wires may have enhanced dispersability, respectively.

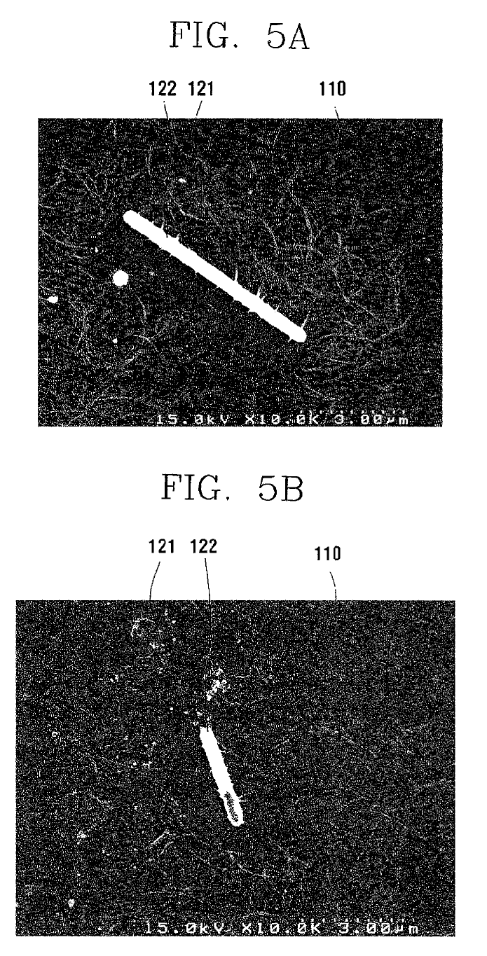

Hereinafter, a conductive film fabricated by the aforementioned method will be explained with reference to FIGS. 4 and 5. FIG. 4 is a sectional view taken along line ‘IV-IV’ in FIG. 1, and FIGS. 5A and 5B are enlarged views of the conductive film of FIG. 1, which show the conductive film photographed by a scanning electron microscope (SEM).

The light transmissive substrate 110 is formed of a transmissive material. The electrode layer 120 implemented as the carbon nanotubes 121 are coated is formed on one surface of the substrate 110. On the electrode layer 120, the metal wires 122 are disposed so as to be mixed with the carbon nanotubes 121. The carbon nanotubes 121 may include at least one of single-walled carbon nanotubes, double-walled carbon nanotubes, and multi-walled carbon nanotubes.

Referring to FIG. 4, the metal wires 122 may have a diameter of 1˜2000 nm larger than that of the carbon nanotubes 121. The metal wires shown in FIG. 5 were analyzed through a scanning electron microscopy (SEM). The conductive film 100 has a light transmission characteristic owing to the minute diameter of the carbon nanotubes 121, and maintains transmittance by the metal wires 122. And, the conductive film 100 has enhanced electric conductivity by the metal wires 122. Owing to a high strength, a high stiffness, and a high chemical stability of the carbon nanotubes 121, the conductive film 100 may have an enhanced endurance.

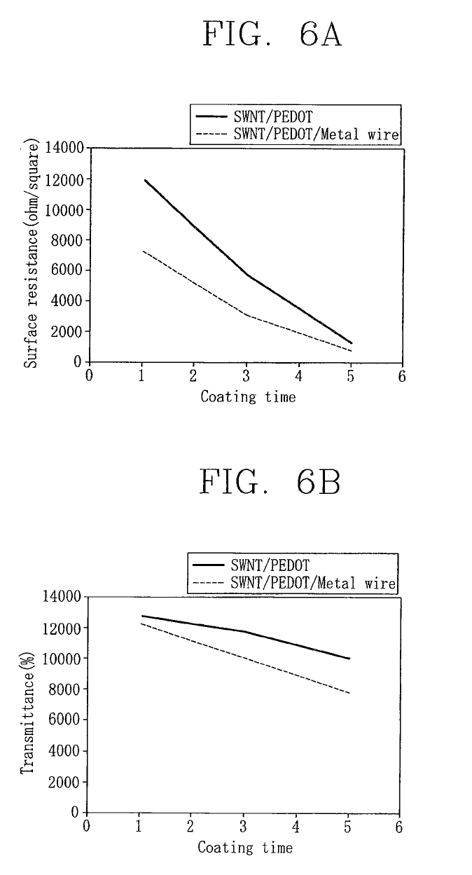

FIGS. 6A and 6B are graphs respectively showing surface resistance and transmittance of the conductive film fabricated by the method of FIG. 2.

FIG. 6A is a graph showing a surface resistance of the conductive film, the surface resistance measured by a four-terminal resistance measuring device. And, FIG. 6B is a graph showing transmittance of the conductive film, the transmittance measured by ultraviolet rays. The SWNT/PEDOT indicates a conductive film fabricated without metal wires, whereas SWNT/PEDOT/Metal wire indicates a conductive film fabricated with using metal wires. Referring to FIG. 6A, the conductive film having metal wires has a low surface resistance even by a small number of coating frequency. And, referring to FIG. 6B, the conductive film having metal wires has transmittance scarcely varied according to coating time since wire-shaped metal has been added to the conductive film.

In the present invention, the conductive film may be formed in a simpler manner by mixing the carbon nanotubes and the metal wires to each other. Accordingly, the conductive film may have a more uniform electric conductivity.

Furthermore, owing to the metal wires, the conductive film of the present invention may reduce the surface resistance with maintaining the transmittance. This may allow the conductive film to have an enhanced endurance.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A method for fabricating a conductive film, comprising:
preprocessing carbon nanotubes by at least one of a cutting step using ultrasonic wave, and a chemical reaction step with acid;
dispersing the carbon nanotubes in a solvent;
mixing metal wires with the carbon nanotubes dispersion solution; and
forming an electrode layer by coating the mixed resultant on a substrate.

2. The method of claim 1, wherein the carbon nanotubes comprise at least one of:
a first group processed by the cutting step using ultrasonic wave; and
a second group processed to have hydrophilicity through the chemical reaction step with acid.

3. The method of claim 1, wherein the solvent comprises at least one of dimethylformamide (DMF), N-methyl-2-pyrrolidone (NMP), ethyl alcohol, water and chlorobenzene.

4. The method of claim 1, further comprising synthesizing the metal wires by reacting a plurality of different materials with each other.

5. The method of claim 4, wherein the synthesizing step comprises:
a heating step for heating an ethylene glycol solution;
an adding step for adding reactants to the solution for a chemical reaction; and
a generating step for generating metal wires by centrifugally separating the solution.

6. The method of claim 1, wherein the metal wires have a diameter of 1˜2000 nanometers.

7. The method of claim 1, wherein the metal wires have a length of 1˜100 μm.

8. The method of claim 1, wherein the metal wires comprise at least one of gold, silver, copper, and platinum.

9. The method of claim 1, further comprising adding a conductive polymer to the solvent.

10. The method of claim 9, wherein the conductive polymer comprises at least one of poly 3,4-ethylenedioxythiophene (PEDOT), polypyrrole, and polyaniline.

11. The method of claim 1, further comprising adding an ionic liquid material to the solvent.

12. The method of claim 11, wherein the ionic liquid material comprises at least one of 1-butyl-3-methyl imidazolium, 1-hexyl-3-methyl imidazolium and 1-methyl-3-methyl imidazolium.

13. The method of claim 1, further comprising surface-processing for chemically processing a surface of the substrate so as to implement hydrophilicity or hydrophobicity.

14. A conductive film, comprising:
a transparent substrate;
an electrode layer formed by coating carbon nanotubes on one surface of the substrate; and
metal wires arranged on the electrode layer so as to be mixed with the carbon nanotubes.

15. The conductive film of claim 14, wherein the carbon nanotubes are formed of at least one of single-walled carbon nanotubes, double-walled carbon nanotubes, and multi-walled carbon nanotubes.

16. The conductive film of claim 14, wherein the metal wires have a diameter of 1˜2000 nanometers.

17. The conductive film of claim 14, wherein the metal wires have a length of 1˜100 μm.

18. A method for fabricating a conductive film, comprising:
synthesizing metal wires through a chemical reaction among a plurality of compounds;
dispersing the metal wires and carbon nanotubes in a solvent; and
forming an electrode layer on a surface of a transparent substrate by coating the dispersion solution onto the transparent substrate.
